(19) United States
(12) Patent Application Publication
(10) Pub. No.: US 2022/0299754 A1
(43) Pub. Date: Sep. 22, 2022

(54) MEMS WITH POLARIZATION CONVERSION AND OPTICAL BEAM SCANNER BASED THEREON

(71) Applicant: Facebook Technologies, LLC, Menlo Park, CA (US)

(72) Inventors: Jacques Gollier, Bellevue, WA (US); Katherine Marie Smyth, Seattle, WA (US)

(21) Appl. No.: 17/205,922

(22) Filed: Mar. 18, 2021

(51) Int. Cl. G02B 26/08; G02B 27/28; G02B 26/10; G09G 3/02

(52) U.S. Cl. CPC G02B 26/0833; G02B 27/283; G02B 26/10; G09G 3/02

(57) ABSTRACT

Unwanted reflections in a polarization diversity based optical beam scanner of a projector display may be reduced by mounting a quarter-wave plate optically in contact with the scanning mirror. This lowers the amplitude of the reflection from a rear surface of the quarter-wave plate. A residual reflection from the quarter-wave plate to mirror interface will be scanned with the main scanned light beam, reducing brightness and noticeability of image artifacts caused by undesired or spurious reflections in the optical beam scanner.

### TECHNICAL FIELD

The present disclosure relates to electromechanical and optical devices, and in particular to optical beam scanners usable in displays, remote sensing, and the like.

### BACKGROUND

Visual displays are used to provide information to viewer(s) including still images, video, data, etc. Visual displays have applications in diverse fields including entertainment, education, engineering, science, professional training, advertising, to name just a few examples. Some visual displays, such as TV sets, display images to several users, and some visual display systems are intended for individual users.

An artificial reality system generally includes a near-eye display (e.g., a headset or a pair of glasses) configured to present content to a user. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images) and the surrounding environment by viewing the surrounding environment through a “combiner” component. The combiner of a wearable display is typically transparent to environmental light but includes some light routing optic to direct the display light into the user's field of view.

Compact display devices are desired for wearable displays. Because a display unit of a wearable display system is usually worn on the head of a user, a large, bulky, unbalanced, and/or heavy display device would be cumbersome and may be uncomfortable for the user to wear. Compact display devices require compact and efficient light sources, image projectors, beam scanners, lightguides, focusing and redirecting optics, etc. Compact display devices include multiple densely spaced optical components that may cause unwanted reflections in the optical train.

### BRIEF DESCRIPTION OF THE DRAWINGS

Exemplary embodiments will now be described in conjunction with the drawings, in which:

FIG. 1A is a schematic cross-sectional view of a display device using a microelectromechanical system (MEMS) based optical beam scanner with polarization conversion;

FIG. 1B is a partial cross-sectional view of a beam scanner of the display device of FIG. 1A showing origins of undesired reflections in the optical train of the beam scanner;

FIG. 2 is a schematic cross-sectional view of a display device using a MEMS-based optical scanner with polarization conversion using a quarter-wave plate (QWP) mounted on a tiltable reflector of the MEMS to reduce unwanted reflections;

FIG. 3 is a schematic cross-sectional view of a display device embodiment using a MEMS-based optical scanner with image light propagating through an opening in the tiltable reflector of the MEMS;

FIG. 4 is a schematic cross-sectional view of a display device embodiment a MEMS-based optical scanner with polarization conversion and a polarization-selective in-coupling grating;

FIG. 5 is a schematic cross-sectional view of a MEMS-based optical scanner variant with a meniscus-shaped MEMS protective optical window; and

FIG. 6 is a view of an augmented reality (AR) display of this disclosure having a form factor of a pair of eyeglasses and using an optical beam scanner of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

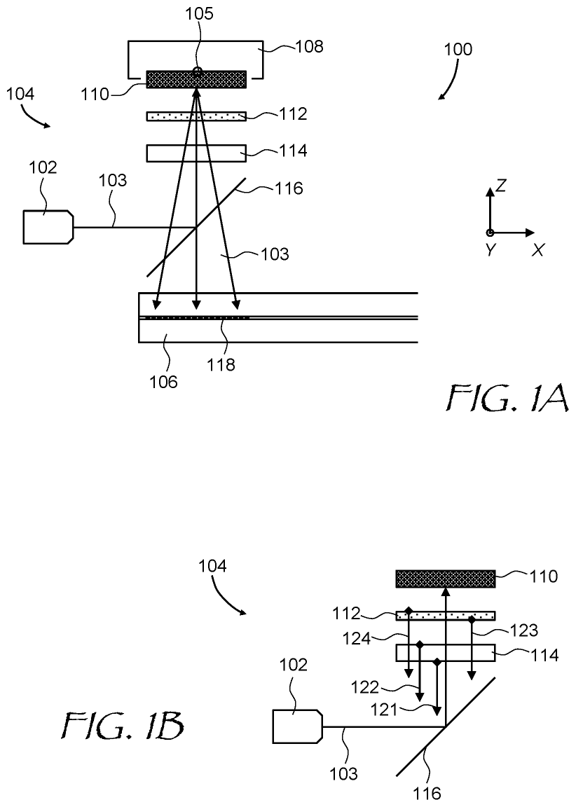

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1A-1B, and FIGS. 2-5, similar reference numerals denote similar elements.

In a scanning projector display, a collimated light beam is scanned across a field of view of the display to raster an image in angular domain for observation by a viewer. Any undesired reflection of the collimated light from a surface within an optical train that does not shift or scan as the light beam is scanned may form a bright dot in the field of view of the viewer. Such dots and other fixed and bright artifacts are readily noticeable, and may be distracting to the viewer.

To save space and provide a wider field of view of the display, polarization beam folding may be used. In a polarization beam folding configuration, also referred to as polarization diversity, a polarization-selective element, such as a polarization beamsplitter (PBS), may be used to separate the incoming and scanned light beams. A polarization-converting element such as a quarter-wave plate (QWP) may be used to convert between two orthogonal polarizations of the light beam propagated twice through the QWP in a common portion of the incoming and scanned beam light paths. A light beam reflected from a QWP surface may result in a steady reflection that does not shift or sweep as the collimated beam is scanned, creating an undesired bright spot in the image being projected by the display. A reflection from the surface of the QWP facing the scanning mirror may create such a steady reflection.

In accordance with the present disclosure, the unwanted reflections and their effects on the generated image may be reduced by mounting the QWP optically in contact with the scanning mirror. This achieves two goals. First, the amplitude of the reflection goes down due to the QWP contacting the mirror. Second, whatever residual reflection from the QWP-mirror interface will be scanned with the main scanned light beam. This considerably reduces brightness and noticeability of image artifacts caused by undesired or spurious reflections.

In accordance with the present disclosure, there is provided an optical beam scanner comprising a microelectromechanical system (MEMS) comprising a reflective surface tiltable about a first axis. The reflective surface is configured to receive and angularly scan a light beam having a first polarization. The optical beam scanner further comprises a quarter-wave layer in contact with the reflective surface and tiltable with the reflective surface as a unit. The quarter-wave layer is configured for changing the first polarization of the light beam propagated through the quarter-wave layer, reflected from the reflective surface, and propagated back through the quarter-wave layer to a second, different polarization, e.g. an orthogonal polarization. The optical beam scanner may further include a polarization-selective optical element disposed in a first path of the light beam impinging onto the reflective surface, and in a second path of the light beam angularly scanned by the reflective surface. The polarization-selective optical element is configured to separate the first and second paths of the light beam by polarization. The polarization-selective optical element may include a polarization-selective reflector such as a polarization beam splitter (PBS), for example.

In some embodiments, the polarization-selective reflector is curved, and the tiltable reflective surface and the quarter-wave layer have an opening for propagating the light beam through the reflective surface and the quarter-wave layer by focusing the light beam through the opening. The curved polarization-selective reflector may be configured to at least partially collimate the light beam focused through the opening to impinge onto the tiltable reflective surface. The polarization-selective optical element may include a polarization-selective diffraction grating.

In some embodiments, the optical beam scanner further includes a meniscus optical element in an optical path between the MEMS and the polarization-selective optical element. The meniscus optical element may serve as an optical window for environmental protection of the tiltable reflective surface of the MEMS. The meniscus optical element may have a non-zero optical power, and accordingly the light beam impinging onto the tiltable reflective surface of the MEMS may be diverging or converging.

The quarter-wave layer may be laminated onto the tiltable reflective surface. The quarter-wave layer may include at least one of: a polymer liquid crystal layer; a dielectric layer comprising oriented sub-wavelength structures; or a stretched polymer film.

In accordance with the present disclosure, there is provided a display device comprising a light source for emitting a light beam having a first polarization and an optical beam scanner of this disclosure, receiving and scanning the light beam. The display device may further include a pupil-replicating waveguide in the second path of the light beam. The polarization-selective optical element may include a polarization-selective diffraction grating in contact with the pupil-replicating waveguide.

In accordance with the present disclosure, there is further provided a MEMS comprising a reflective unit tiltable about a first axis, the reflective unit comprising a reflective surface and a quarter-wave layer supported by the reflective surface. The reflective unit is configured to receive and angularly scan a light beam having a first polarization. The quarter-wave layer is configured for changing the first polarization of the light beam propagated through the quarter-wave layer, reflected from the reflective surface, and propagated back through the quarter-wave layer to a second, different polarization, e.g. an orthogonal polarization. The reflective unit may also be tiltable about a second axis non-parallel to the first axis, e.g. it may be scanned in X- and Y-angles. The MEMS may further include a meniscus-shaped optical window for receiving the light beam and outputting the angularly scanned light beam.

Referring now to FIG. 1A, a display device 100 includes a light source 102 for emitting a light beam 103. An optical beam scanner 104 is coupled to the light source 102. The purpose of the optical beam scanner 104 is to angularly scan or sweep the light beam 103 thereby rastering an image in angular domain. A pupil-replicating waveguide 106 may be coupled to the optical beam scanner 104. The purpose of the pupil-replicating waveguide 106 is to provide multiple offset copies of scanned light beam 103, so as to extend the image in angular domain over an eyebox of the display device 100.

In the embodiment of FIG. 1A, the optical beam scanner 104 includes a microelectromechanical system (MEMS) 108 comprising a reflective surface 110, e.g. a mirror or a reflective diffractive grating, tiltable about an axis 105 parallel to Y-axis, and optionally about another axis (not shown for brevity) parallel to X-axis. The reflective surface 110 is configured to receive and angularly scan the light beam 103. A quarter-wave plate (QWP) 112 is disposed on the optical path of the light beam 103 impinging onto the reflective surface 110 of the MEMS 108. An optical window 114 may be provided for environmental protection of the tiltable reflective surface 110 of the MEMS 108. A polarization-selective optical element, e.g. a polarization beam splitter (PBS) 116, may be disposed in a first path of the light beam 103 impinging onto the reflective surface 110, and in a second path of the light beam 103 angularly scanned by the reflective surface 110.

In operation, the light source 102 emits the light beam 103 having a linear polarization perpendicular to the plane of FIG. 1A, i.e. parallel to Y-axis. The light beam 103 is reflected by the PBS 116 to propagate to the reflective surface 110 of the MEMS 108 through the optical window 114 and the QWP 112. The reflective surface 110 reflects the light beam 103 at a variable angle, forming an image in angular domain by rastering the light beam 103 while varying optical power and/or color of the light beam 103 in a coordinated manner with the scanning. The QWP 112 is configured to change the polarization of the light beam 103 propagated through the QWP 112, reflected from the reflective surface 110, and propagated back through the QWP 112 to a second, different polarization, e.g. to an orthogonal linear polarization perpendicular to Y-axis. The orthogonally polarized light beam 103 propagates through the PBS 116 to the pupil-replicating waveguide 106. An in-coupling grating 118 of the pupil-replicating waveguide 106 redirects the light beam to propagate in the pupil-replicating waveguide 106.

Undesired reflections in the optical beam scanner 104, also termed ghost reflections, are illustrated in FIG. 1B. A first Fresnel reflection 121 originates from the outer side of the optical window 114, and a second Fresnel reflection 122 originates from the inner side of the optical window 114. The first 121 and second 122 Fresnel reflections will be polarized at the initial linear polarization (i.e. parallel to Y-axis), and as such will be reflected by the PBS 116 to propagate back to the light source 102 and will mostly not be coupled into the pupil-replicating waveguide 106, except for a small portion that leaks through the PBS 116. The same can be stated about a third Fresnel reflection 123 from an outer side of the QWP 112. A fourth Fresnel reflection 124, however, will have an orthogonal state of polarization due to double propagation through the QWP 112, and as such will propagate towards the pupil-replicating waveguide 106, forming a bright dot in the displayed image.

The reflected optical power remains concentrated into a single pixel of the image since the light beam 103 is collimated, and the first 121 to fourth 124 Fresnel reflections do not scan over the whole image. In looking at a relative brightness of those parasitic reflections in the image, one needs to consider an amplification factor equal to the square of the image resolution. As an example, if the image is 1000×1000 pixels, the amplification factor (AF) is equal to 10⁶. The implication is that even if all surfaces have antireflective (AR) coatings with a reflection coefficient R=10⁻³, brightness of the static ghost spots will still be 1000× brighter than the rest of the image being displayed. As explained above, for the first 121 to third 123 Fresnel reflections, the light beam 103 did not cross the QWP 112. So, their polarization did not rotate, meaning that those beams will be reflected by the PBS 116 back towards the light source 102 and will not reach the pupil-replicating waveguide 106. Assuming an extinction ratio for the PBS 116 of 10⁻³ and AR coatings of 10⁻³, the power getting back to the image will be 10⁻⁶ which is good enough to compensate the 10⁶ amplification factor. The fourth Fresnel reflection 124 is different because light went through the bulk of the QWP 112 twice, meaning that the polarization has rotated. In that case, the PBS 116 will be transmissive and there will be no polarization filtering of that ghost reflection. A 1000× brighter pixel will be readily noticeable by the display's user as a ghost or artifact. Thus, the fourth Fresnel reflection 124 dominates spurious reflections in the optical beam scanner 104.

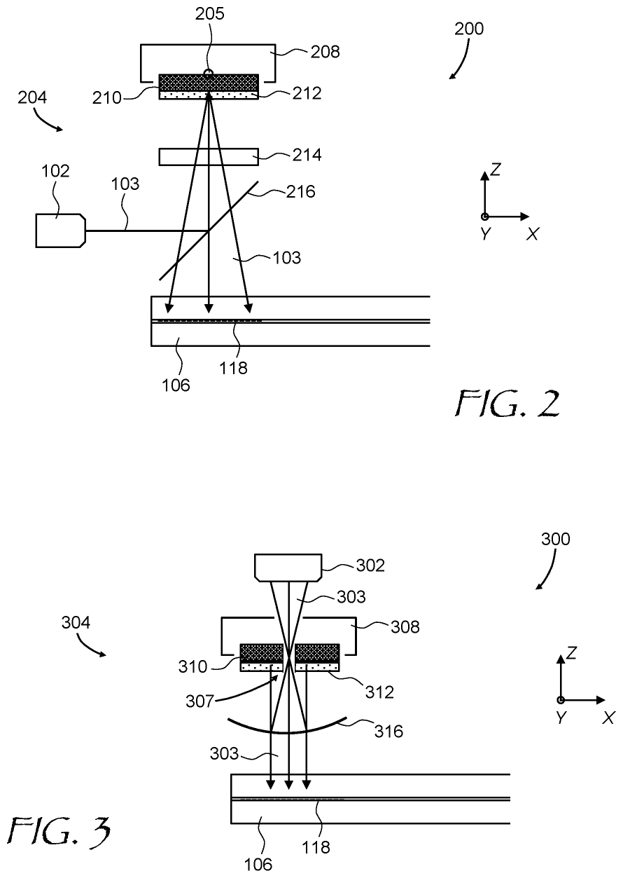

In accordance with this disclosure, one way to mitigate the strongest fourth Fresnel reflection 124 is to dispose the QWP 112 on the reflective surface 110 and to tilt the QWP 112 on the reflective surface 110 together. This is illustrated in FIG. 2, which shows a display device 200 including the same light source 102 and the pupil-replicating waveguide 106 as the display device 100 of FIG. 1A, but a different optical beam scanner 204. The optical beam scanner 204 of FIG. 2 includes a MEMS 208 comprising a reflective surface 210, e.g. a mirror or a reflective diffractive grating, tiltable about an first axis 205 parallel to Y-axis, and optionally tiltable about a second, different axis (not shown), e.g. parallel to X-axis. The reflective surface 210 is configured to receive and angularly scan the light beam 103. A quarter-wave layer 212 is disposed in the optical path of the light beam 103 impinging onto the reflective surface 210 of the MEMS 208, in contact with the reflective surface 210 and tiltable with the reflective surface 210 as a single reflective unit. For example, the quarter-wave layer 212 may be laminated onto the reflective surface 210, optically contacted with the reflective surface 210, or fabricated on the reflective surface 210. Herein and throughout the specification, the term “in contact with” means no air gap between the reflective surface 210 and the quarter-wave layer 212, such that the refractive index does not drop to that of air between the reflective surface 210 and the quarter-wave layer 212, causing a strong Fresnel reflection. In some embodiments, the refractive index step in going from the quarter-wave layer 212 to the reflective surface 210 is small enough not to cause noticeable reflections of the propagating light beam 103. In other words, the reflective surface 210 and the quarter-wave layer 212 may be impedance-matched to one another. In some embodiments, the refractive index step can be less than 0.2, less than 0.1, less than 0.05, or even less than 0.025. Herein and throughout the specification, the terms “QWP” or “quarter-wave layer”, which may be used interchangeably, denote a waveplate with optical retardation of an odd number of quarter wavelengths, and may include a single waveplate or a compound waveplate including several sub-layers of waveplates of same or different thicknesses and/or retardations, with optic axes not necessarily parallel to one another.

An optical window 214 may be provided for environmental protection of the tiltable reflective surface 210 and the quarter-wave layer 212 of the MEMS 208. A polarization-selective optical element, e.g. a PBS 216, may be disposed in a first path of the light beam 103 impinging onto the reflective surface 210, and in a second path of the light beam 103 angularly scanned by the reflective surface 210. The polarization-selective optical element (i.e. the PBS 216 in this example) may be integrated into the optical window 214.

In operation, the light beam 103 emitted by the light source 102 may have e.g. a linear polarization parallel to Y-axis. The light beam 103 is reflected by the PBS 216 to propagate to the reflective surface 210 of the MEMS 108 through the optical window 214 and the quarter-wave layer 212. The reflective surface 210 reflects the light beam 103 at a variable angle, forming an image in angular domain by rastering the light beam 103 while varying optical power and/or color of the light beam 103. The quarter-wave layer 212 is configured to change the polarization of the light beam 103 propagated through the QWP 212, reflected from the reflective surface 210, and propagated back through the quarter-wave layer 212 from the first polarization to a second, different polarization, e.g. an orthogonal linear polarization perpendicular to Y-axis. The orthogonally polarized light beam 103 propagates through the PBS 216 to the pupil-replicating waveguide 106, is redirected by the in-coupling grating 118, and is guided by the pupil-replicating waveguide 106 to form an image for observation by a viewer.

Ghost reflections in the optical beam scanner 204 of FIG. 2 are similar to the ghost reflections in the optical beam scanner 104 of FIGS. 1A and 1B, including the first 121 to third 123 reflections. A fourth reflection originates at the interface between the quarter-wave layer 212 and the tiltable reflective surface 210. Due to the direct contact between the quarter-wave layer 212 and the reflective surface 210, this reflection may be of a smaller magnitude than a corresponding reflection in the optical beam scanner 104 of FIGS. 1A and 1B, which significantly reduces the ghost magnitude. Furthermore, since the quarter-wave layer 212 and the reflective surface 210 are tilted together as a unit, the fourth reflection will be scanned with the main reflected beam 103 and as such will be much less noticeable as compared to the case of FIGS. 1A and 1B.

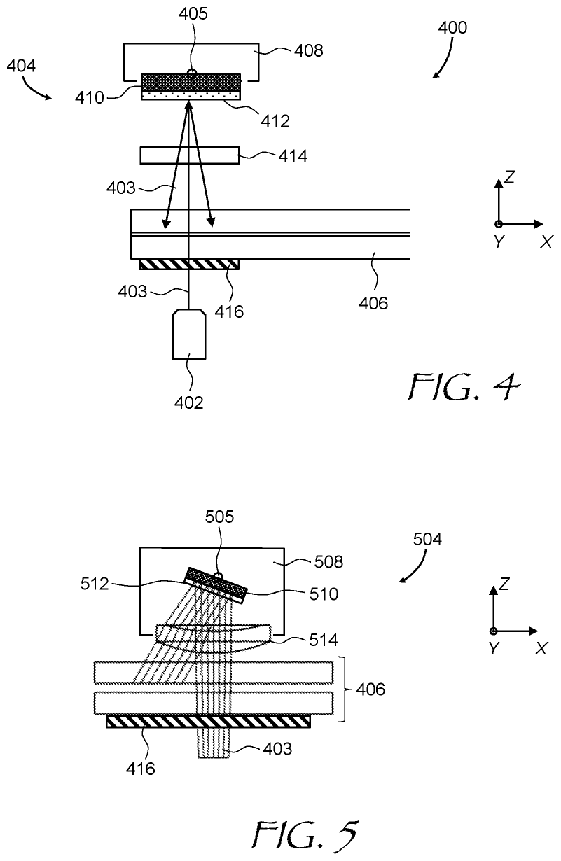

Referring to FIG. 3, a display device 300 includes a light source 302 providing a converging light beam 303, the same pupil-replicating waveguide 106 as the display device 100 of FIG. 1A, and an optical beam scanner 304. The optical beam scanner 304 of FIG. 3 includes a MEMS 308 having a reflective tiltable surface 310, e.g. a mirror or a reflective diffractive grating. The reflective surface 310 is configured to receive and angularly scan the light beam 303. A quarter-wave layer 312 is disposed in the optical path of the light beam 303 impinging onto the reflective surface 310 of the MEMS 308, in contact with the reflective surface 310 and tiltable with the reflective surface 310 as a unit. The quarter-wave layer 312 may be laminated onto the reflective surface 310, optically contacted with the reflective surface 310, or fabricated on the reflective surface 310, for example. The tiltable reflective surface 310 and the quarter-wave layer 312 have a through opening 307 for propagating the converging light beam 303 by focusing the light beam 303 through the opening 307. The opening 307 may be tapered on one or both ends to better propagate the light beam 303. The optical beam scanner 304 further includes a curved polarization-selective reflector 316 configured to at least partially collimate the light beam 303 focused through the opening 307 to impinge onto the tiltable reflective surface 310. As the reflective surface 310 is tilted about one axis or two axes as the case may be, the at least partially collimated light beam 303 is scanned in angle, forming an image in angular domain. The scanned light beam 303 is redirected by the in-coupling grating 118 to propagate in the pupil-replicating waveguide 106.

Turning to FIG. 4, a display device 400 includes a light source 402, an optical beam scanner 404, and a pupil-replicating waveguide 406. The optical beam scanner 404 includes a MEMS 408 having a reflective tiltable surface 410, e.g. a mirror or a reflective diffractive grating tiltable about an axis 405, and optionally tiltable about a second axis non-parallel to the axis 405. The reflective surface 410 is configured to receive and angularly scan the light beam 403. A quarter-wave layer 412 is disposed in the optical path of the light beam 403 impinging onto the reflective surface 410 of the MEMS 408, in contact with the reflective surface 410 and tiltable with the reflective surface 410 as a unit. The quarter-wave layer 412 may be e.g. laminated onto the reflective surface 410, optically contacted with the reflective surface 410, or fabricated on the reflective surface 410. The MEMS 408 of the optical beam scanner 304 may further include an optical window 414 for environmental protection of the tiltable reflective surface 410 and the quarter-wave layer of the MEMS 408. A polarization-selective diffraction grating 416 may be provided in contact with the pupil-replicating waveguide 406. The polarization-selective diffraction grating 416 plays the role of the polarization-selective optical element separating optical paths of the incoming light beam and the scanned light beam. At the same time, the polarization-selective diffraction grating 416 may perform the function of the in-coupling element, coupling the scanned light beam 403 into the pupil-replicating waveguide 406 for propagation in the pupil-replicating waveguide 406.

In operation, the light source 402 emits a polarized light beam 403 that propagates (upwards in FIG. 4, i.e. in Z-axis direction) through the polarization-selective diffraction grating 416 substantially without diffracting on the polarization-selective diffraction grating 416, propagates through the pupil-replicating waveguide 406, the optical window 414, the quarter-wave layer 412, is reflected by the reflective surface 410 at a variable angle, propagates back through the quarter-wave layer 412 adopting a different polarization state that may be orthogonal to the original polarization state, propagates through the optical window 414 and the pupil-replicating waveguide 406, and is in-coupled by the polarization-selective diffraction grating 416 to propagate in the pupil-replicating waveguide 406.

Referring now to FIG. 5, a MEMS-based optical beam scanner 504 may be used in place of the optical beam scanner 404 of FIG. 4. The optical beam scanner 504 of FIG. 5 includes a MEMS 508 having a tiltable reflective surface 510, a QWP or quarter-wave layer 512 mounted in contact with the reflective surface 510 to be tiltable with the reflective surface 510 as a unit about at least one axis 505, and a meniscus-shaped optical window 514. The polarization-selective grating 416 operates as a polarization-selective optical element separating the optical paths of the light bean 403 by polarization. The polarization-selective grating 416 is supported by the pupil-replicating waveguide 406, and also operates to in-couple the light beam 403 into the pupil-replicating waveguide 406.

The meniscus-shaped optical window 514 is disposed in an optical path between the reflective surface 510 of the MEMS 508 and the polarization-selective grating 416. Reflections from the meniscus-shaped optical window 514 will not be collimated and as such will not show in the image in angular domain conveyed by the pupil-replicating waveguide 406 as single dots. Instead, the energy of these ghost reflections will be spread out over a much larger area, lowering the intensity and detectability of the ghost reflections in the image being displayed. The meniscus-shaped optical window 514 may have a non-zero optical power, i.e. a non-zero focusing or defocusing power. In this case, the light beam 403 emitted by the light source 402 (FIG. 2) may need to be slightly converging or diverging, such that the light beam 403 propagated twice through the meniscus-shaped optical window 514 is properly collimated before impinging onto the pupil-replicating waveguide 406. Such a configuration has an additional advantage of the light beam entering the pupil-replicating waveguide 406 for the first time, i.e. from the bottom in FIG. 5, being non-collimated and thus avoiding collimated ghost reflections into the pupil-replicating waveguide 406 by a residual diffraction of the light beam 403 on the polarization-selective grating 416. Unwanted diffraction of the collimated light may cause sharp ghost artifacts in the displayed image. Nonetheless in some embodiments, the meniscus-shaped optical window 514 may have zero optical power. Furthermore, in some embodiments, a meniscus optical element may be a separate element from the MEMS optical window. It is further noted that any of such embodiments of the MEMS 504 with a meniscus window and/or separate meniscus-shaped optical element may be used in any of the optical beam scanners and display devices disclosed herein.

By way of a non-limiting example, the quarter-wave layer on a tiltable MEMS surface may include at least one of a polymer liquid crystal (PLC) layer, a stretched polymer film, or a dielectric thin film with highly oriented, sub-wavelength features. The quarter-wave layer/dielectric thin film may include a single birefringent layer or a stack of several thin birefringent sub-layers, such that the total birefringence of the stack is equal to an odd number of quarter wavelengths. Optic axis orientations and sub-layer thicknesses may be selected to provide a broadband quarter-wavelength performance of the stack.

In the dielectric thin films, the highly oriented, sub-wavelength (or nano-scale) features may be required to achieve the anisotropy necessary for birefringence. The thin film material should be transparent over the visible wavelength range, and may be amorphous or single crystal to avoid scatter from grain boundaries, and may have a high refractive index. Polycrystalline materials may also work effectively, depending on grain size. Therefore, dielectrics, such as titanium dioxide, zirconium oxide, indium tin oxide, silicon dioxide, etc., may work more effectively, as disclosed in an article by Devlin, R. C., Khorasaninejad, M., Chen, W. T., Oh, J., & Capasso, F. (2016), Broadband high-efficiency dielectric metasurfaces for the visible spectrum. Proceedings of the National Academy of Sciences, 113(38), 10473-10478, which is incorporated herein by reference. These films may include photonic structures or directional nano-columns manufactured via glancing angle deposition (GLAD).

GLAD is a physical vapor deposition process where controlled substrate motion results in a directional nano-column morphology. The nano-columns vary in angle (tilt) with the substrate surface, but in most cases are perpendicular. For increased uniformity and birefringence and to reduce scattering, multiple layers are typically required for a GLAD QWP film. Serial bi-deposition, where the deposition direction is varied periodically by ±θ between layers, is a typical approach for a multi-layer GLAD film. Layer(s) deposited via GLAD can be also be patterned via lift-off, as described in an article by MacNally, S., Smith, C., Spaulding, J., Foster, J., & Oliver, J. B. (2020). Glancing-angle-deposited silica films for ultraviolet wave plates, Applied Optics, 59(5), A155-A161, which is incorporated herein by reference.

For photonic structures, a nano-antenna or other spatially varying 2D polygon patterned structure can be used to achieve broadband efficiency. Depending on the geometry, nanometer scale patterning in the range of tens to hundreds of nanometers, for example from 10 nm to 900 nm, is performed via interference or electron beam lithography and lift-off or PVD/ALD of the dielectric over the etched features to realize the final patterned, dielectric photonic structure. Nanoantennas are described in an article by Ni, X., Kildishev, A. V., & Shalaev, V. M. (2013), Metasurface holograms for visible light. Nature communications, 4(1), 1-6, which is incorporated herein by reference.

The advantage of dielectric thin films with oriented, sub-wavelength features for the QWP is MEMS fabrication process compatibility. With a MEMS compatible process, the QWP fabrication can be integrated as an intermediate step in the MEMS mirror fabrication process. For low-loss mirrors, dielectric films are also compatible with high and ultra-high vacuum packaging whereas polymer-based films, like PLC, are typically avoided in these applications because of comparatively high outgassing.

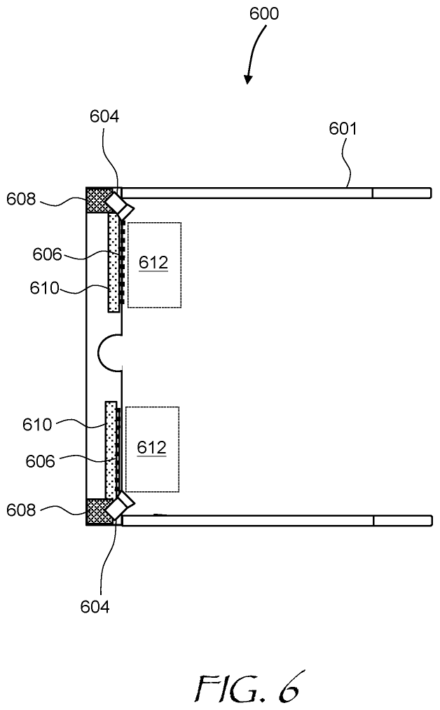

Referring to FIG. 6, an augmented reality (AR) near-eye display 600 includes a frame 601 having a form factor of a pair of eyeglasses. The frame 601 supports, for each eye: a projector 608 including any of the optical beam scanners described herein, a pupil-replicating waveguide 610 optically coupled to the projector 608, an eye-tracking camera 604, a plurality of illuminators 606, and an eye-tracking camera controller 607. The illuminators 606 may be supported by the pupil-replicating waveguide 610 for illuminating an eyebox 612. The projector 608 provides a fan of light beams carrying an image in angular domain to be projected into a user's eye. The pupil-replicating waveguide 610 receives the fan of light beams and provides multiple laterally offset parallel copies of each beam of the fan of light beams, thereby extending the projected image over the eyebox 612.

Multi-emitter laser sources may be used in the projector 608. Each emitter of the multi-emitter laser chip may be configured to emit image light at an emission wavelength of a same color channel. The emission wavelengths of different emitters of the same multi-emitter laser chip may occupy a spectral band having the spectral width of the laser source.

In some embodiments, the projector 608 may include two or more multi-emitter laser chips emitting light at wavelengths of a same color channel or different color channels. For AR applications, the pupil-replicating waveguide 610 can be transparent or translucent to enable the user to view the outside world together with the images projected into each eye and superimposed with the outside world view. The images projected into each eye may include objects disposed with a simulated parallax, so as to appear immersed into the real world view.

The purpose of the eye-tracking cameras 604 is to determine position and/or orientation of both eyes of the user. Once the position and orientation of the user's eyes are known, a gaze convergence distance and direction may be determined. The imagery displayed by the projectors 608 may be adjusted dynamically to account for the user's gaze, for a better fidelity of immersion of the user into the displayed augmented reality scenery, and/or to provide specific functions of interaction with the augmented reality. In operation, the illuminators 606 illuminate the eyes at the corresponding eyeboxes 612, to enable the eye-tracking cameras to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with illuminating light, the latter may be made invisible to the user. For example, infrared light may be used to illuminate the eyeboxes 612.

The function of the eye-tracking camera controllers 607 is to process images obtained by the eye-tracking cameras 604 to determine, in real time, the eye gazing directions of both eyes of the user. In some embodiments, the image processing and eye position/orientation determination functions may be performed by a central controller, not shown, of the AR near-eye display 600. The central controller may also provide control signals to the projectors 608 to generate the images to be displayed to the user, depending on the determined eye positions, eye orientations, gaze directions, eyes vergence, etc.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An optical beam scanner comprising:
a microelectromechanical system (MEMS) comprising a reflective surface tiltable about a first axis, wherein the reflective surface is configured to receive and angularly scan a light beam having a first polarization; and
a quarter-wave layer in contact with the reflective surface and tiltable therewith as a unit, wherein the quarter-wave layer is configured for changing the first polarization of the light beam propagated through the quarter-wave layer, reflected from the reflective surface, and propagated back through the quarter-wave layer to a second, different polarization.

2. The optical beam scanner of claim 1, further comprising a polarization-selective optical element disposed in a first path of the light beam impinging onto the reflective surface, and in a second path of the light beam angularly scanned by the reflective surface;
wherein the polarization-selective optical element is configured to separate the first and second paths of the light beam by polarization.

3. The optical beam scanner of claim 2, wherein the polarization-selective optical element comprises a polarization-selective reflector.

4. The optical beam scanner of claim 3, wherein the polarization-selective reflector comprises a polarization beam splitter (PBS).

5. The optical beam scanner of claim 3, wherein the polarization-selective reflector is curved, wherein the tiltable reflective surface and the quarter-wave layer comprise an opening for propagating therethrough the light beam by focusing the light beam through the opening;
wherein the curved polarization-selective reflector is configured to at least partially collimate the light beam focused through the opening to impinge onto the tiltable reflective surface.

6. The optical beam scanner of claim 2, wherein the polarization-selective optical element comprises a polarization-selective diffraction grating.

7. The optical beam scanner of claim 2, further comprising a meniscus optical element in an optical path between the MEMS and the polarization-selective optical element.

8. The optical beam scanner of claim 7, wherein the MEMS comprises an optical window for environmental protection of the tiltable reflective surface, wherein the optical window comprises the meniscus optical element.

9. The optical beam scanner of claim 7, wherein the meniscus optical element has a non-zero optical power, wherein the light beam impinging onto the tiltable reflective surface of the MEMS is diverging or converging.

10. The optical beam scanner of claim 1, wherein the quarter-wave layer is laminated onto the tiltable reflective surface.

11. The optical beam scanner of claim 1, wherein the quarter-wave layer comprises at least one of: a polymer liquid crystal layer; a dielectric layer comprising oriented sub-wavelength structures; or a stretched polymer film.

12. A display device comprising:
a light source for emitting a light beam having a first polarization; and
an optical beam scanner comprising:
a microelectromechanical system (MEMS) comprising a reflective surface tiltable about a first axis, wherein the reflective surface is configured to receive and angularly scan the light beam received from the light source; and
a quarter-wave layer in contact with the reflective surface and tiltable therewith as a unit, wherein the quarter-wave layer is configured for changing the first polarization of the light beam propagated through the quarter-wave layer, reflected from the reflective surface, and propagated back through the quarter-wave layer to a second, different polarization; and
a polarization-selective optical element disposed in a first path of the light beam impinging onto the reflective surface, and in a second path of the light beam angularly scanned by the reflective surface, wherein the polarization-selective optical element is configured to separate the first and second paths by polarization.

13. The display device of claim 12, wherein the polarization-selective optical element comprises a polarization-selective reflector.

14. The display device of claim 13, wherein the tiltable reflective surface and the quarter-wave layer comprise an opening for propagating therethrough the light beam by focusing the light beam through the opening, wherein the polarization-selective reflector is curved to at least partially collimate the light beam focused through the opening to impinge onto the tiltable reflective surface.

15. The display device of claim 12, wherein the optical beam scanner further comprises a meniscus optical element in an optical path between the MEMS and the polarization-selective optical element.

16. The display device of claim 15, wherein the meniscus optical element has a non-zero optical power, wherein the light beam emitted by the light source is diverging or converging.

17. The display device of claim 12, further comprising a pupil-replicating waveguide in the second path of the light beam, wherein the polarization-selective optical element comprises a polarization-selective diffraction grating in contact with the pupil-replicating waveguide.

18. A microelectromechanical system (MEMS) comprising:
a reflective unit tiltable about a first axis, the reflective unit comprising a reflective surface and a quarter-wave layer supported thereby;
wherein the reflective unit is configured to receive and angularly scan a light beam having a first polarization, wherein the quarter-wave layer is configured for changing the first polarization of the light beam propagated through the quarter-wave layer, reflected from the reflective surface, and propagated back through the quarter-wave layer to a second, different polarization.

19. The MEMS of claim 18, wherein the reflective unit is tiltable about a second axis non-parallel to the first axis.

20. The MEMS of claim 18, further comprising a meniscus-shaped optical window for receiving the light beam and outputting the angularly scanned light beam.
